(19) United States
(12) Patent Application Publication
(10) Pub. No.: US 2024/0125243 A1
(43) Pub. Date: Apr. 18, 2024

(54) COOLING FEATURES FOR A COMPONENT OF A GAS TURBINE ENGINE

(71) Applicant: Raytheon Technologies Corporation, Farmington, CT (US)

(72) Inventors: Billie R. Maldonado, Amesbury, MA (US); Jeremy T. Drake, South Berwick, ME (US); Terence Tyler, East Waterboro, ME (US); Dmitriy A. Romanov, Portland, ME (US)

(21) Appl. No.: 17/965,311

(22) Filed: Oct. 13, 2022

(51) Int. Cl. F01D 11/24; F01D 25/12

(52) U.S. Cl. CPC F01D 11/24; F01D 25/12; F05D 2220/32; F05D 2240/55; F05D 2260/202

(57) ABSTRACT

A component for a gas turbine engine, including: at least one internal channel extending through a first portion of the component, the at least one internal channel having at least one inlet opening and at least one outlet opening each being in fluid communication with the at least one internal channel; a plurality of cooling features extending from a surface of the at least one internal channel; and at least one internal channel extending through a second portion of the component, the at least one internal channel extending through the second portion of the component is in fluid communication with the at least one internal channel extending through the first portion of the component, the second portion being located on top of the first portion, the at least one internal channel extending through the second portion of the component having a plurality of openings extending from the least one internal channel extending through the second portion of the component through the plurality of cooling features to an outer surface of the component.

### BACKGROUND

This disclosure relates to cooling features for a component of gas turbine engine and more particularly, a component of a gas turbine engine with the aforementioned cooling features.

Gas turbine engines typically include a compressor section, a combustor section and a turbine section. During operation, air is pressurized in the compressor section and is mixed with fuel and burned in the combustor section to generate hot combustion gases. The hot combustion gases are communicated through the turbine section, which extracts energy from the hot combustion gases to power the compressor section and other gas turbine engine loads.

Both the compressor and turbine sections may include alternating series of rotating blades and stationary vanes that extend into the core flow path of the gas turbine engine. For example, in the turbine section, turbine blades rotate and extract energy from the hot combustion gases that are communicated along the core flow path of the gas turbine engine. The turbine vanes, which generally do not rotate, guide the airflow and prepare it for the next set of blades.

Blade outer air seals (BOAS), vanes, blades and other components are located in hot sections of the gas turbine engine. In some instances these components are cooled with cooling air that passes through an interior cavity of the component. Accordingly, it is desirable to provide a cooled hot section component with features that improves the cooling efficiency.

### BRIEF DESCRIPTION

Disclosed is a component for a gas turbine engine, including: at least one internal channel extending through a first portion of the component, the at least one internal channel extending through the first portion of the component having at least one inlet opening and at least one outlet opening each being in fluid communication with the at least one internal channel extending through the first portion of the component; a plurality of cooling features extending from a surface of the at least one internal channel extending through the first portion of the component; and at least one internal channel extending through a second portion of the component, the at least one internal channel extending through the second portion of the component is in fluid communication with the at least one internal channel extending through the first portion of the component, the second portion being located on top of the first portion, the at least one internal channel extending through the second portion of the component having a plurality of openings extending from the least one internal channel extending through the second portion of the component through the plurality of cooling features to an outer surface of the component.

In addition to one or more of the features described above, or as an alternative to any of the foregoing embodiments, the component is a blade outer air seal.

In addition to one or more of the features described above, or as an alternative to any of the foregoing embodiments, the blade outer air seal is formed from a bottom core, a top core and an outboard face, the outboard face defining the least one inlet opening and the bottom core defining the at least one internal channel extending through the first portion of the component.

In addition to one or more of the features described above, or as an alternative to any of the foregoing embodiments, the bottom core defines the plurality of cooling features.

In addition to one or more of the features described above, or as an alternative to any of the foregoing embodiments, the plurality of cooling features are pedestals.

In addition to one or more of the features described above, or as an alternative to any of the foregoing embodiments, the least one internal channel extending through the first portion of the component is a plurality of internal channels and the at least one internal channel extending through the second portion of the component is a plurality of internal channels.

In addition to one or more of the features described above, or as an alternative to any of the foregoing embodiments, a plurality of cooling holes extend from the at least one internal channel extending through the second portion of the component to an outer end surface of the blade outer air seal.

Also disclosed is a component for a gas turbine engine, including: at least one internal channel extending through the component, the at least one internal channel having an inlet opening and an outlet opening each being in fluid communication with the at least one internal channel, the at least one internal channel having a spiral configuration extending from the inlet opening to the outlet opening.

In addition to one or more of the features described above, or as an alternative to any of the foregoing embodiments, the component is a blade outer air seal.

In addition to one or more of the features described above, or as an alternative to any of the foregoing embodiments, the least one internal channel is a plurality of internal channels.

Also disclosed is a gas turbine engine, including; a component configured to receive a cooling air flow, the component including at least one internal channel extending through a first portion of the component, the at least one internal channel extending through the first portion of the component having at least one inlet opening and at least one outlet opening each being in fluid communication with the at least one internal channel extending through the first portion of the component; a plurality of cooling features extending from a surface of the at least one internal channel; and at least one internal channel extending through a second portion of the component, the at least one internal channel extending through the second portion of the component is in fluid communication with the at least one internal channel extending through the first portion of the component, the second portion being located on top of the first portion, the at least one internal channel extending through the second portion of the component having a plurality of openings extending from the least one internal channel extending through the second portion of the component through the plurality of cooling features to an outer surface of the component.

In addition to one or more of the features described above, or as an alternative to any of the foregoing embodiments, the component is a blade outer air seal.

In addition to one or more of the features described above, or as an alternative to any of the foregoing embodiments, the blade outer air seal is formed from a bottom core, a top core and an outboard face, the outboard face defining the least one inlet opening and the bottom core defining the at least one internal channel extending through the first portion of the component.

In addition to one or more of the features described above, or as an alternative to any of the foregoing embodiments, the bottom core defines the plurality of cooling features.

In addition to one or more of the features described above, or as an alternative to any of the foregoing embodiments, the plurality of cooling features are pedestals.

In addition to one or more of the features described above, or as an alternative to any of the foregoing embodiments, the least one internal channel extending through the first portion of the component is a plurality of internal channels and the at least one internal channel extending through the second portion of the component is a plurality of internal channels.

In addition to one or more of the features described above, or as an alternative to any of the foregoing embodiments, a plurality of cooling holes extend from the at least one internal channel extending through the second portion of the component to an outer end surface of the blade outer air seal.

### BRIEF DESCRIPTION OF THE DRAWINGS

The following descriptions should not be considered limiting in any way. With reference to the accompanying drawings, like elements are numbered alike:

FIG. 1 is a schematic, partial cross-sectional view of a gas turbine engine in accordance with this disclosure;

FIG. 2 is a schematic view of a two-stage high pressure turbine of the gas turbine engine;

FIG. 3 is a schematic view of a blade outer air seal for use in a gas turbine engine;

FIG. 4 is an exploded view of a component formed in accordance with the present disclosure;

FIGS. 5-7 are cross-sectional views of a component formed in accordance with the present disclosure;

FIG. 8 is a perspective view of a core for forming a component in accordance with the present disclosure;

FIG. 9 is a cross-sectional view of a portion of a component formed from the core illustrated in FIG. 8; and

FIG. 10 is a perspective view illustrating air flow through the portion of the component illustrated in FIG. 9.

### DETAILED DESCRIPTION

A detailed description of one or more embodiments of the disclosed apparatus and method are presented herein by way of exemplification and not limitation with reference to the FIGS.

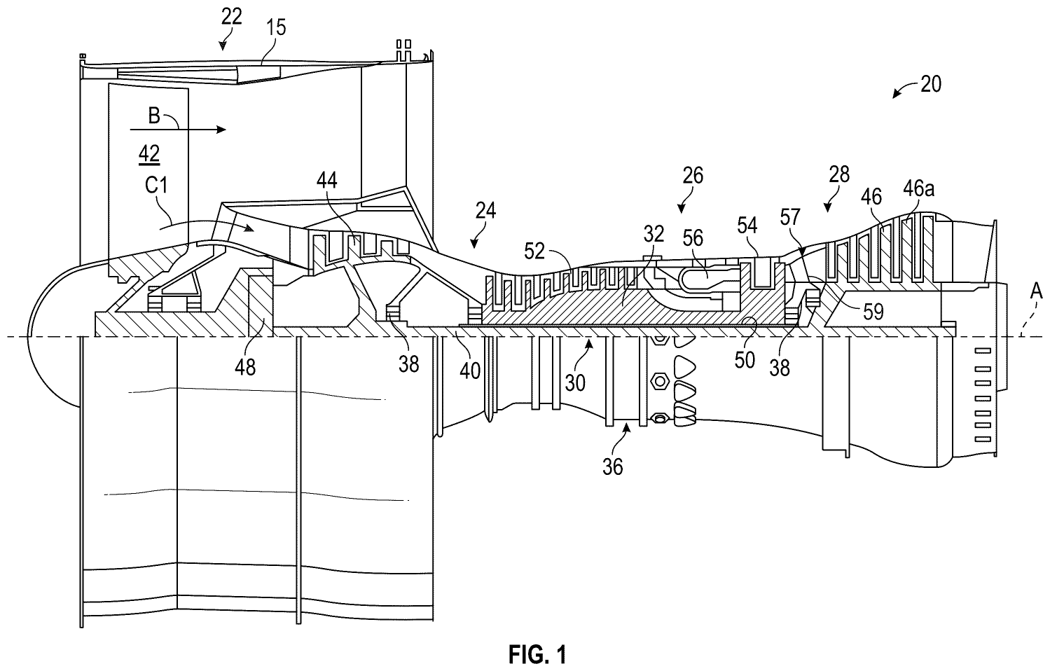

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include other systems or features. The fan section 22 drives air along a bypass flow path B in a bypass duct, while the compressor section 24 drives air along a core flow path Cl for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first or low pressure compressor 44 and a first or low pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second or high pressure compressor 52 and a second or high pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present disclosure is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet (10,688 meters). The flight condition of 0.8 Mach and 35,000 ft (10,688 meters), with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second (350.5 m/sec).

In a further example, the fan 42 includes less than about 26 fan blades. In another non-limiting embodiment, the fan 42 includes less than about 20 fan blades. Moreover, in one further embodiment the low pressure turbine 46 includes no more than about 6 turbine rotors schematically indicated at 46a. In a further non-limiting example the low pressure turbine 46 includes about 3 turbine rotors. A ratio between the number of blades of the fan 42 and the number of low pressure turbine rotors 46a is between about 3.3 and about 8.6. The example low pressure turbine 46 provides the driving power to rotate the fan section 22 and therefore the relationship between the number of turbine rotors 46a in the low pressure turbine 46 and the number of blades in the fan section 22 discloses an example gas turbine engine 20 with increased power transfer efficiency.

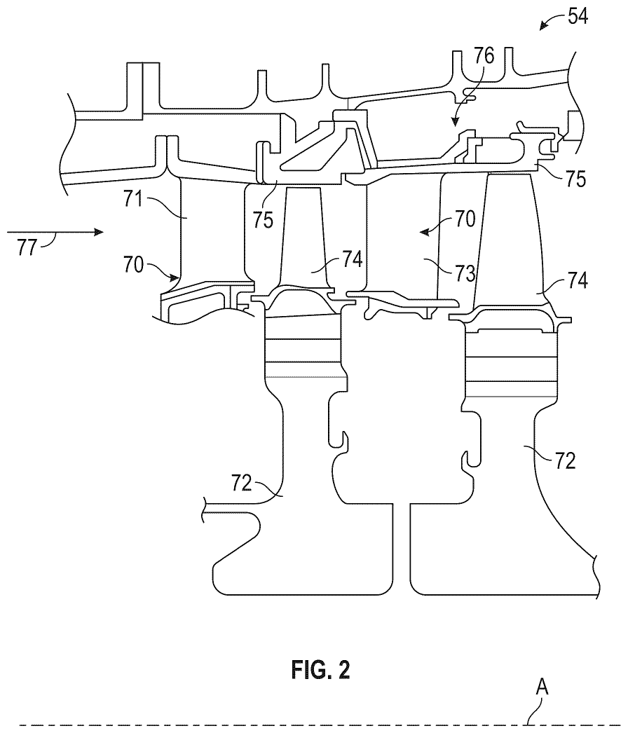

FIG. 2 illustrates a portion of the high pressure turbine (HPT) 54. FIG. 2 also illustrates a high pressure turbine stage vanes 70 one of which (e.g., a first stage vane 71) is located forward of a first one of a pair of turbine disks 72 each having a plurality of turbine blades 74 secured thereto. The turbine blades 74 rotate proximate to blade outer air seals (BOAS) 75 which are located aft of the first stage vane 71. The other vane 70 is located between the pair of turbine disks 72. This vane 70 may be referred to as the second stage vane 73. As used herein the first stage vane 71 is the first vane of the high pressure turbine section 54 that is located aft of the combustor section 26 and the second stage vane 73 is located aft of the first stage vane 71 and is located between the pair of turbine disks 72. In addition, blade outer air seals (BOAS) 75 are disposed between the first stage vane 71 and the second stage vane 73. The high pressure turbine stage vanes 70 (e.g., first stage vane 71 or second stage vane 73) are one of a plurality of vanes 70 that are positioned circumferentially about the axis A of the engine in order to provide a stator assembly 76. Hot gases from the combustor section 26 flow through the turbine in the direction of arrow 77. Although a two-stage high pressure turbine is illustrated other high pressure turbines are considered to be within the scope of various embodiments of the present disclosure.

The high pressure turbine (HPT) is subjected to gas temperatures well above the yield capability of its material. In order to mitigate such high temperature detrimental effects, a supply of cooling air is applied to an internal cavity of components located in the hot sections of the gas turbine engine. This cooling air may also be used for surface film-cooling by supplying the cooling air through cooling holes drilled on the components.

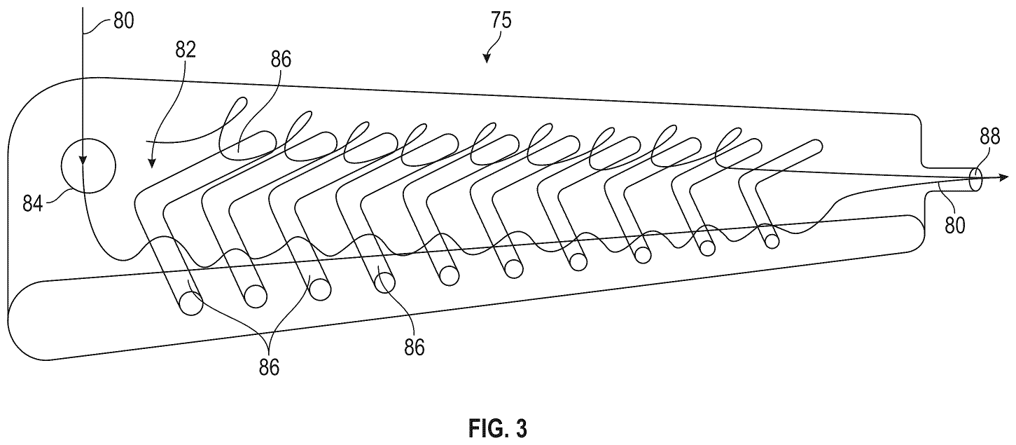

FIG. 3 schematically illustrates a blade outer air seal (BOAS) 75. Cooling air flow is illustrated by arrows 80 that is introduced into a cavity or channel 82 of the blade outer air seal 75 via at least one inlet opening 84. The cooling air flow is directed through the channels 82 that extend internally in the blade outer air seal 75. The channels 82 are provided with trip strips 86. These trip strips 86 can be generally referred to as protrusions or cooling features that extend from a surface of the channel. The trip strips create turbulences in the cooling air flow which enhances convection. The channel 82 is in fluid communication with the at least one inlet opening 84 and at least one outlet opening 88. The cooling air exiting the at least one outlet opening 88 may be used for surface film cooling. The at least one outlet opening 88 may be located away from the at least one inlet opening 84 such that maximum cooling efficiently can be achieved internally before the cooling air exits the channel 82 via the at least one outlet opening 88. However prior manufacturing techniques have limited the size and detail in which the trip strips 86 can be produced.

In accordance with the present disclosure tools and/or cores with highly complex three-dimensional features are contemplated where components are formed with features for providing enhanced cooling.

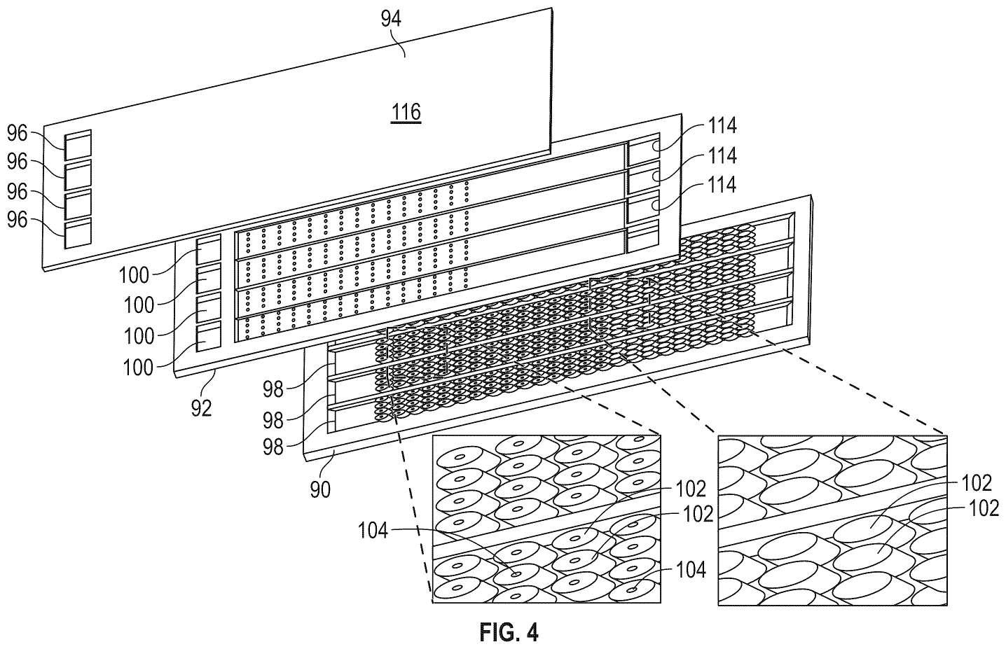

For example and referring now to at least FIGS. 4-7 views of a component formed in accordance with the present disclosure is illustrated. FIG. 4 is an exploded view of the component.

In accordance with an exemplary embodiment of the present disclosure the component is a blade outer air seal 75. As illustrated in at least FIGS. 4-7, the blade outer air seal is formed from a bottom core 90, a top core 92 and an outboard face 94. The outboard face 94 has a plurality of inlet openings 96 that are in fluid communication with a plurality of channels or channel 98 formed in the bottom core 90. The inlet openings 96 are in fluid communication with the plurality of channels 98 via openings 100.

The plurality of channels 98 comprising a plurality of pedestals 102 for increased heat transfer. Some of the pedestals 102 are provided with film cooling holes 104 that extend to an outer surface 106 of the bottom core 90. The film cooling holes 104 also extend to an interior channel 108 formed between the top core 92 the outboard face 94.

In addition, cooling holes 110 are also formed in the blade outer air seal 75 that extend from the interior channel 108 to an outer end surface 112 of the blade outer air seal 75.

Air flow through the blade outer air seal 75 is illustrated by the arrows in FIG. 6. As such, cooling air is directed from an outboard air supply to the channels 98 in the bottom core 90 where it contacts the pedestals 102 to transfer heat from the outer surface 106 to the cooling air. Then the heated air flows to the interior channel 108 through openings 114. This heated air is then cooled by outboard surface 116 which is exposed to cooler temperatures than the outer surface 106. This cools the air before it passes into openings 104 and 110. Once the cooled air passes into openings 104 and 110 it can be used for film cooling of surfaces 106 and 112. In accordance with the present disclosure the outboard surface 116 of the outboard face 94 is radially further from the axis A of the engine 20 than surface 106 when the component is installed in the engine 20.

As illustrated, openings 96 and 100 are located on an opposite end of the blade outer air seal with respect to openings 114 such that the air must travel across an entire length of the blade outer air seal before entering openings 104.

As illustrated in FIG. 7, the height (illustrated by arrows 120) of the cavities defined by the cores may vary. In addition, the size of the openings 104 may vary as well as the size of the pedestals 102 may vary. This is illustrated by arrows 122 and 124.

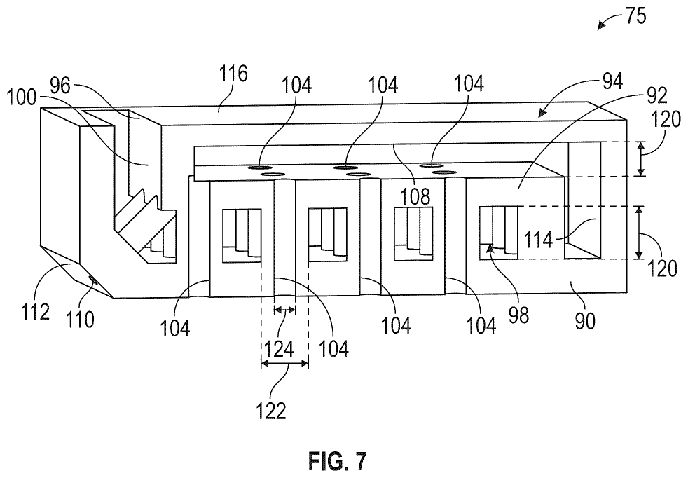

Referring now to FIGS. 8-10, an alternative embodiment of the present disclosure is illustrated. In FIG. 8, a core 130 is illustrated for forming a component with a plurality of spiral channels 132. As mentioned above a desired material is cast into or around the production mold to product the part and then the core is removed. Each spiral channel 132 of the subsequently formed component has an inlet opening 134 and an outlet opening 136. Similar to the previous embodiment, the core 130 may be used to form a blade outer air seal 75 or any other component of the gas turbine engine 20 that requires cooling via cooling air. In addition and as mentioned above, the cooling air exiting the outlet opening 136 may also be used for may be used for surface film cooling. Here the blade outer air seal 75 may comprise a single spiral channel 132 or a plurality of spiral channels 132.

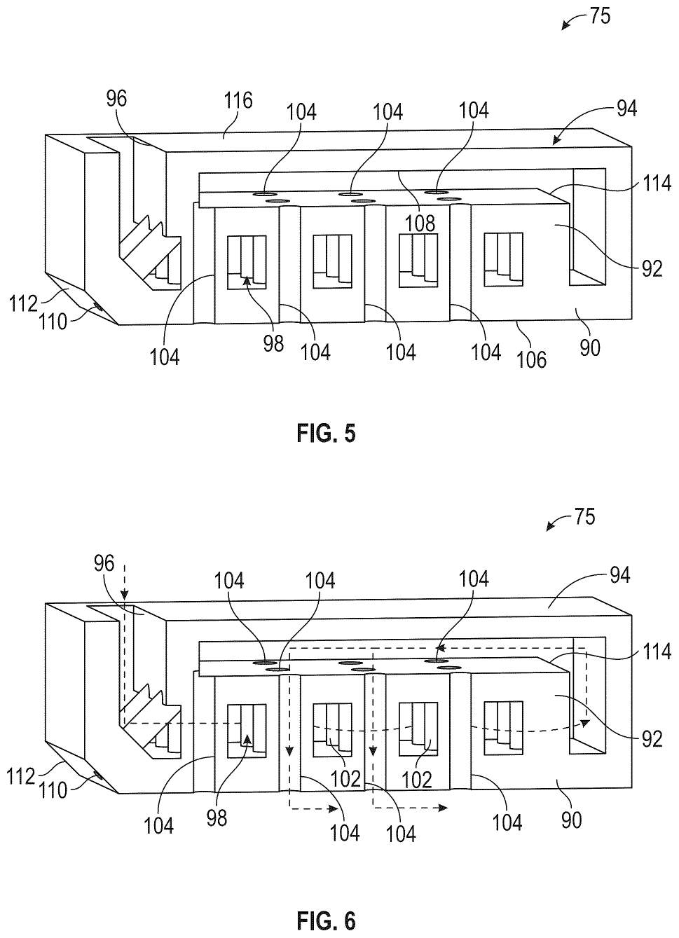

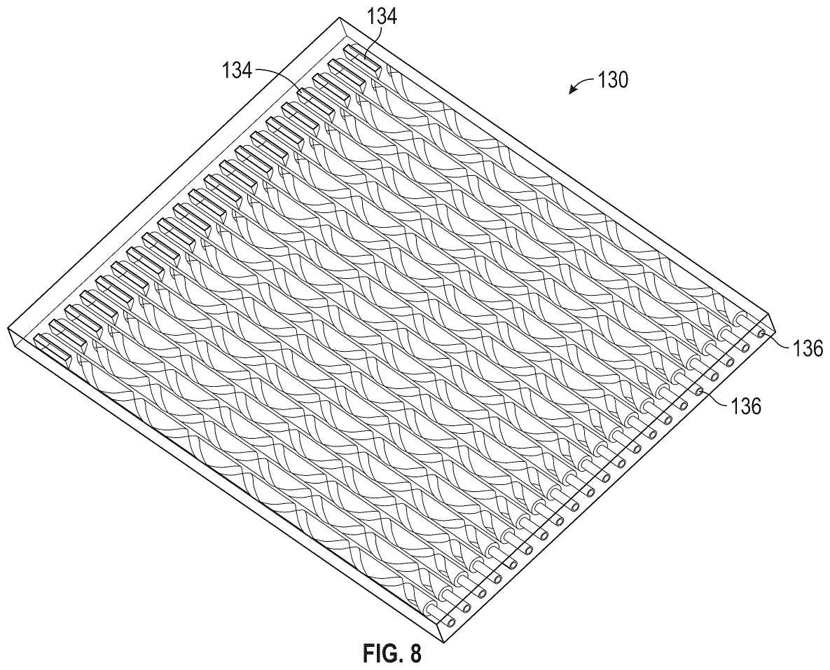

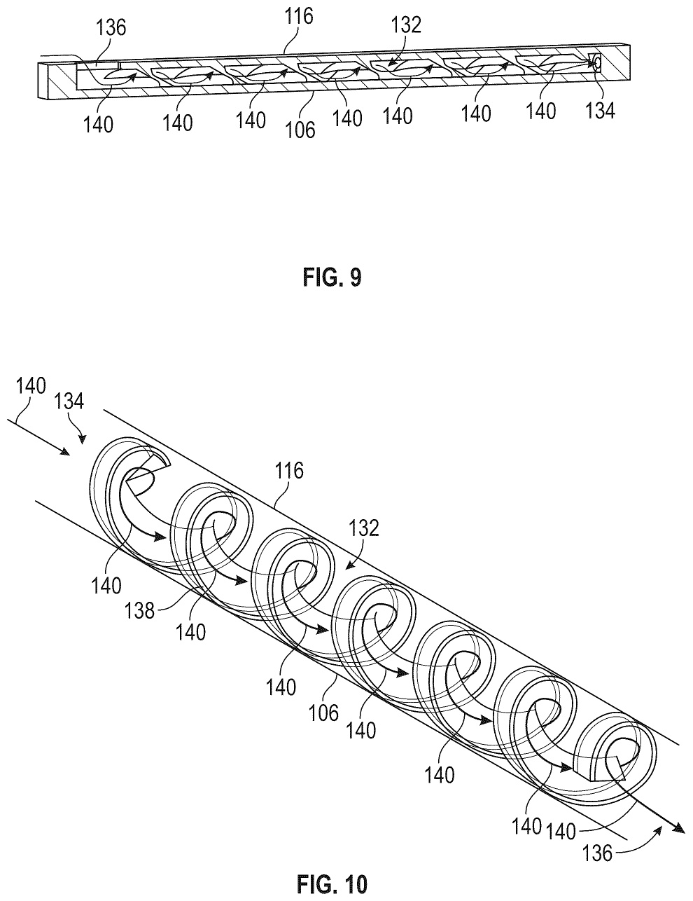

Here the cooling air is directed into a spiral geometry that circulates air from a hotter lower surface (e.g., surface 106 illustrated in at least FIGS. 5-7 and 9 namely, a surface that is radially closer to the engine axis A than surface 116 when the component is installed into the engine 20) to an upper cooler surface (e.g., surface 116 illustrated in at least FIGS. 5-7 and 9 namely, a surface that is radially further from the engine axis A than surface 106 when the component is installed into the engine 20). The cooling air flow is depicted in FIGS. 9 and 10.

FIG. 9 is a cross sectional view of one of the spiral channels 132 formed from the core 130 illustrated in FIG. 8. As illustrated and after the component is formed about the core 130 and the core 130 is subsequently removed, a spiral wall 138 is formed and extends generally from the inlet opening 134 to the outlet opening 136. In other words, FIG. 9 is a cross sectional view of a portion of a component formed from the core 130.

FIG. 10 is a perspective view of one of the spiral walls 138 corresponding to one of the spiral channels 132 formed from the core 130. Air flow through the spiral channel 132 is illustrated by arrows 140. The inlet opening 136, the outlet opening 134, upper surface or cooler surface 116 and the lower surface or hotter surface 106 of the component are also illustrated in at least FIG. 10.

Although a blade outer air seal is illustrated as the component, the component may be any component that requires cooling including but not limited to anyone of the following: blade outer air seals (BOAS), vanes, blades and other components that are required to be cooled by a source of cooling air.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A component for a gas turbine engine, comprising:
at least one internal channel extending through a first portion of the component, the at least one internal channel having at least one inlet opening and at least one outlet opening each being in fluid communication with the at least one internal channel extending through the first portion of the component;
a plurality of cooling features extending from a surface of the at least one internal channel extending through the first portion of the component; and
at least one internal channel extending through a second portion of the component, the at least one internal channel extending through the second portion of the component is in fluid communication with the at least one internal channel extending through the first portion of the component, the second portion being located on top of the first portion, the at least one internal channel extending through the second portion of the component having a plurality of openings extending from the least one internal channel extending through the second portion of the component through the plurality of cooling features to an outer surface of the component.

2. The component according to claim 1, wherein the component is a blade outer air seal.

3. The component according to claim 2, wherein the blade outer air seal is formed from a bottom core, a top core and an outboard face, the outboard face defining the least one inlet opening and the bottom core defining the at least one internal channel extending through the first portion of the component.

4. The component according to claim 3, wherein the bottom core defines the plurality of cooling features.

5. The component according to claim 4, wherein the plurality of cooling features are pedestals.

6. The component according to claim 1, wherein the least one internal channel extending through the first portion of the component is a plurality of internal channels and the at least one internal channel extending through the second portion of the component is a plurality of internal channels.

7. The component according to claim 2, wherein a plurality of cooling holes extend from the at least one internal channel extending through the second portion of the component to an outer end surface of the blade outer air seal.

8. A component for a gas turbine engine, comprising:
at least one internal channel extending through the component, the at least one internal channel having an inlet opening and an outlet opening each being in fluid communication with the at least one internal channel, the at least one internal channel having a spiral configuration extending from the inlet opening to the outlet opening.

9. The component according to claim 1, wherein the component is a blade outer air seal.

10. The component according to claim 9, wherein the least one internal channel is a plurality of internal channels.

11. A gas turbine engine, comprising;
a component configured to receive a cooling air flow, the component including at least one internal channel extending through a first portion of the component, the at least one internal channel extending through the first portion of the component having at least one inlet opening and at least one outlet opening each being in fluid communication with the at least one internal channel extending through the first portion of the component;
a plurality of cooling features extending from a surface of the at least one internal channel; and
at least one internal channel extending through a second portion of the component, the at least one internal channel extending through the second portion of the component is in fluid communication with the at least one internal channel extending through the first portion of the component, the second portion being located on top of the first portion, the at least one internal channel extending through the second portion of the component having a plurality of openings extending from the least one internal channel extending through the second portion of the component through the plurality of cooling features to an outer surface of the component.

12. The gas turbine engine according to claim 11, wherein the component is a blade outer air seal.

13. The gas turbine engine according to claim 12, wherein the blade outer air seal is formed from a bottom core, a top core and an outboard face, the outboard face defining the least one inlet opening and the bottom core defining the at least one internal channel extending through the first portion of the component.

14. The gas turbine engine according to claim 13, wherein the bottom core defines the plurality of cooling features.

15. The gas turbine engine according to claim 13, wherein the plurality of cooling features are pedestals.

16. The gas turbine engine according to claim 11, wherein the least one internal channel extending through the first portion of the component is a plurality of internal channels and the at least one internal channel extending through the second portion of the component is a plurality of internal channels.

17. The gas turbine engine according to claim 12, wherein a plurality of cooling holes extend from the at least one internal channel extending through the second portion of the component to an outer end surface of the blade outer air seal.
